(19) United States
(12) Patent Application Publication
(10) Pub. No.: US 2009/0093143 A1
(43) Pub. Date: Apr. 9, 2009

(54) Electrical card connector with a supporting patch on the contact

(75) Inventors: Han-Ming Zhang, ShenZhen (CN); Nan Hu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/287,434

(22) Filed: Oct. 9, 2008

(30) Foreign Application Priority Data
Oct. 9, 2007 (CN) 200720043547.5

(51) Int. Cl. H01R 12/00; H01R 13/62; B23P 17/00

(52) U.S. Cl. 439/76.1; 439/345; 29/592.1

(57) ABSTRACT

An electrical card connector comprising an insulative housing 1 and a plurality of contacts 2, the insulative housing 1 has a base 13 and two sidewalls 11 extended from the two sides, a plurality of pinholes 120 are defined on the insulative housing 1 receiving corresponding contacts 2, wherein at least one of the contacts 2 has a supporting patch 24 extended from the side.

### BACKGROUND OF THE INVENTION

1. Field of the Invention

The present invention relates to an electrical card connector, especially to an electrical card connector having a supporting patch on the side of the contact so as to securely ensure a retention thereon.

2. Background of the Invention

Electrical cards are known in the art and contain intelligence in the form of a memory circuit or other electronic program. Some form of card readers retrieve the information or data stored on the card. Such cards are used in many applications in today's electronic society, including video cameras, digital still cameras, smart phones, PDAs, music players, ATMs, cable television decoders, toys, games, PC adapters, multi-media cards and other electronic applications, etc.

Example of prior art card-receiving connectors comprises an insulative housing and a plurality of contacts, the insulative housing has a base and two sidewalls extended from the two sides, a plurality of pinholes are defined on the insulative housing receiving corresponding contacts.

Unfortunately, problems continue to be encountered with the electrical card connectors mentioned above. After the injection molding of the insulative housing and the contacts, the temperature of the insulative housing falls rapidly, the thinner part of the insulative housing will be easy to deform and warp, this is harmful to the stability of the usage of the electrical card connector. Therefore, an improved electrical card connector is desired to overcome the disadvantages of the prior arts.

### SUMMARY OF THE INVENTION

An object, therefore, of the invention is to provide a new and improved electrical card connector of the character described able to prevent the deformation of the insulative housing.

In order to achieve the object set forth, an electrical connector in accordance with the present invention comprises an insulative housing and a plurality of contacts, the insulative housing has a base, a retention rib, and two sidewalls extended from the two sides, a plurality of pinholes are defined on the insulative housing receiving corresponding contacts, wherein at least one of the contacts has a supporting patch extended from the side, the supporting is molded with the retention rib.

As disclosed herein, the supporting patch which defined on the contact is to prevent the deformation of the insulative housing.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an assembled perspective view of the electrical card connector without the metal cover;

FIG. 2 is an exploded view of an electrical card connector embodying the concepts of the invention;

FIG. 3 is a perspective view of the contact of the electrical card connector;

FIG. 4 is an assembled perspective view of the electrical card connector;

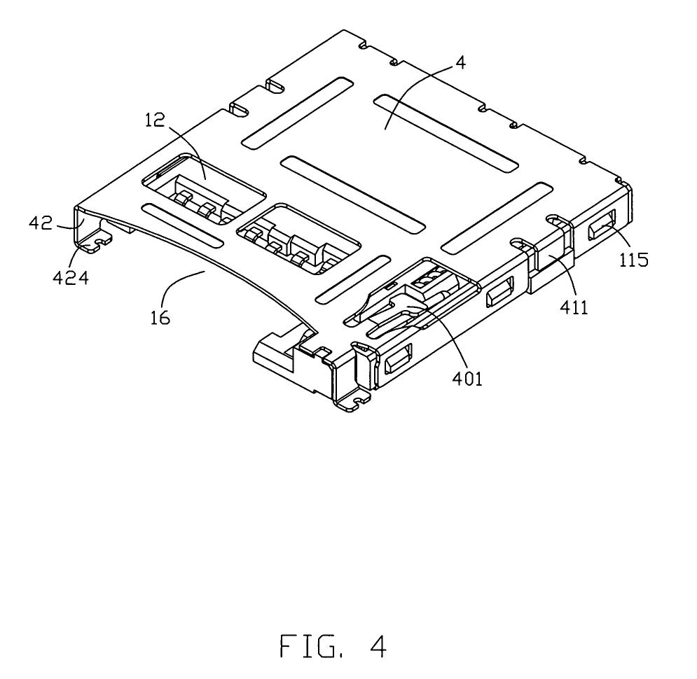

FIG. 5 is an assembled perspective view from a different angle of the electrical card connector.

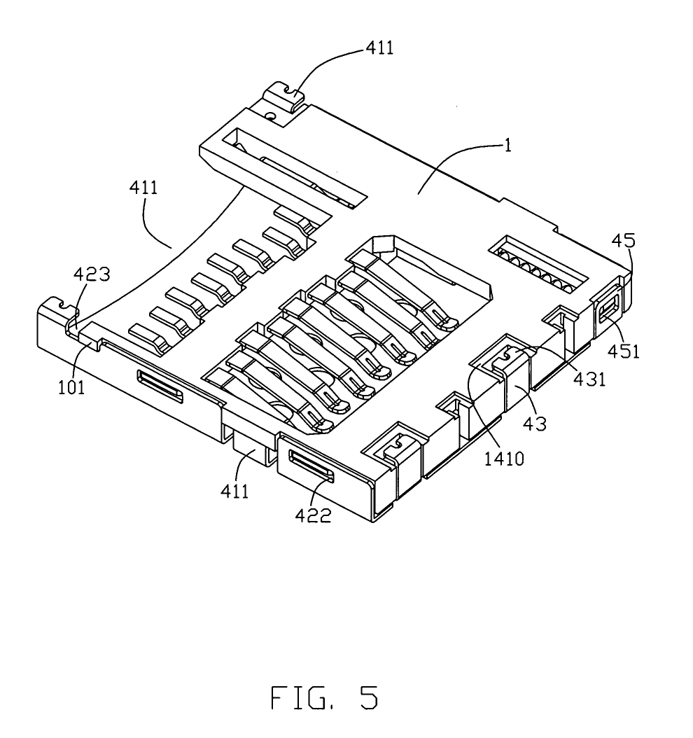

### DETAILED DESCRIPTION OF THE PREFERRED EMBODIMENT

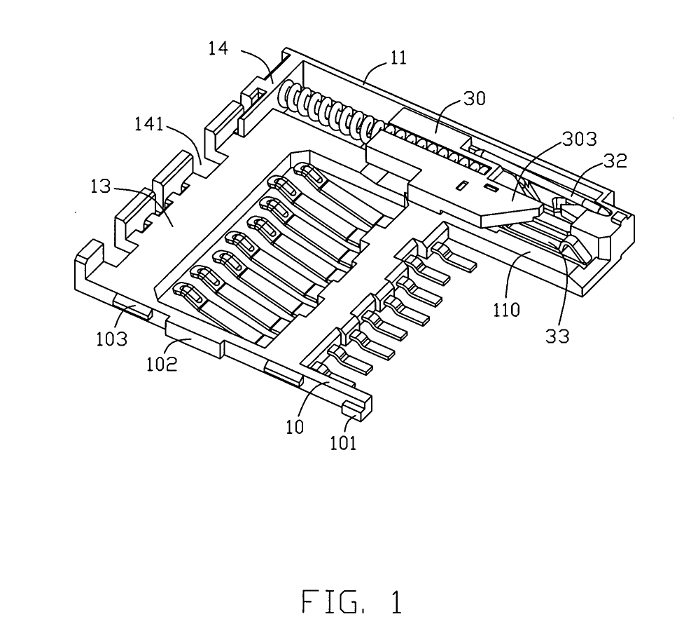

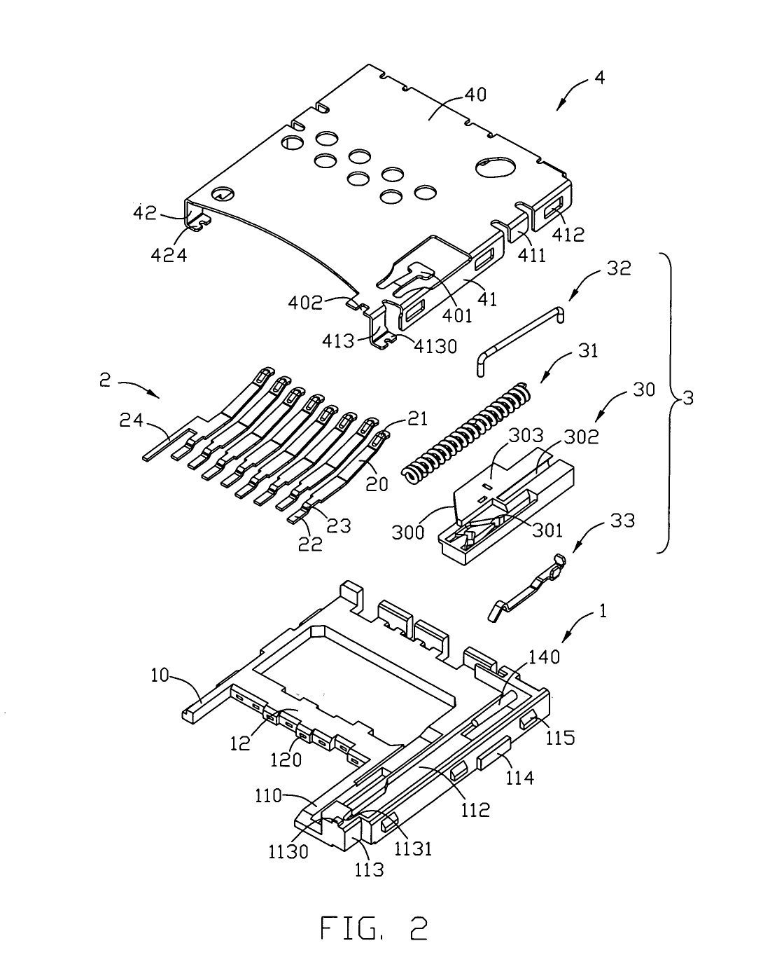

Referring to FIGS. 1-2, an electrical card connector for connecting an electrical card (not shown) to a circuit board (not shown) in accordance with the preferred embodiment of the present invention comprises an insulative housing 1, a plurality of contacts 2 received in the insulative housing 1, an ejector and a metal cover 4.

The insulative housing 1 is consist of a base 13, a retention rib 10 which extends forwardly from the two sides of the base 13 and a sidewall 11, the base 13 extends perpendicularly and forms a backwall 14, the back wall 14 has a positioning pillar 140 and a recess 141. The sidewall 11, the base 13 and the backwall 14 together form a receiving space 16. An insert portion 12 has a plurality of pinholes 120, a passageway 110 is formed at the connecting part of the sidewall 11 and the inserting portion 12, a receiving portion 112 which can receive the slider 30 of the ejector 3 is formed at the front part of the sidewall 11, the end of the sidewall 11 has a positioning portion 113, a plurality of the first protruding portions 115 and the first supporting portions 114 which set between the first protruding portions 115 are formed on the side of the sidewall 11. Correspondingly, several second protruding portions 103 and the second supporting portions 102 which set between the second protruding portions 103 are formed on the side of the retention rib 10, and the side of the retention rib 10 has a block portion 101.

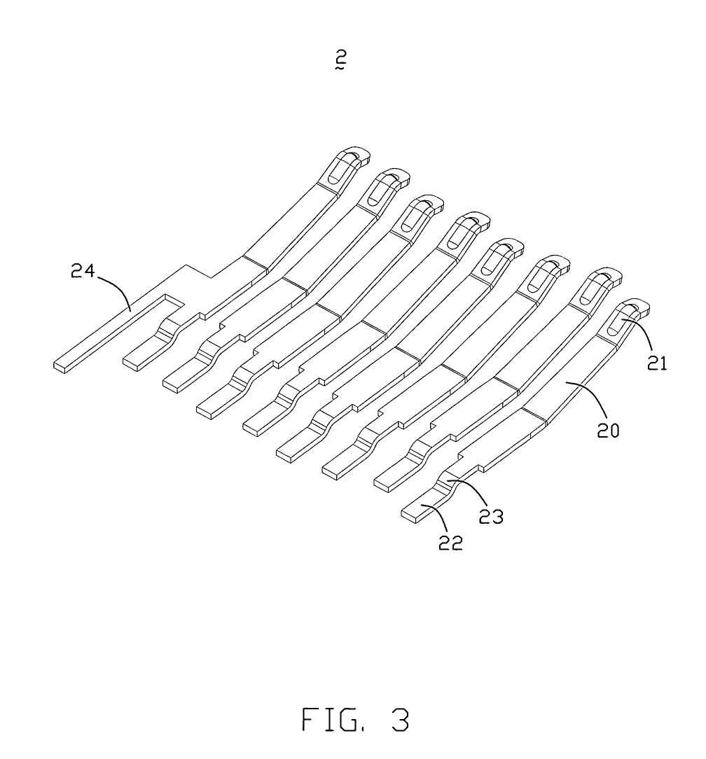

Referring to FIG. 3, each contact 2 includes contact portion 21 and soldering portion 22, the contact portion 21 connected with a transition portion 20, the soldering portion 22 is extended from the bending portion 23, the said soldering portion 22 protrudes from the pinhole 120, the transition portion 20 and the contact portion 21 are received in the receiving space 16 formed by the insert portion 12 and the base 13, the transition portion 20 which is close to the retention rib 10 has a supporting patch 24, the supporting patch 24 insert molded with the retention rib 10.

Referring to FIG. 1 and FIG. 2, the ejector 3 includes a slider 30, a spring 31, a leading pole 32 and a lock sheet 33, the slider 30 extends and forms a push portion 303 which has a leading surface 300. The said slider 30 also has a guard slot 301 and a receiving hole 302 which receives the spring 31, one end of the spring 31 fixed in the positioning pillar 140, the other end receives in the receiving hole 302, one end of the leading pole 32 connected with the receiving hole 1131.

The metal cover 4 includes a main portion 40, the first sidewall 41 and the second sidewall 42, a plurality of openings 412 are set on the first sidewall 41 to cooperate with the first protruding portion 115. An elastic sheet 411 is set on the first sidewall 41, the first sidewall 41 has a soldering sheet 4130 on the bending sheet 413 to cooperate with the positioning portion 113. A recess 402 is formed on the bending sheet 413 so as to cooperate with the locking block 1130. The second sidewall 42 includes retention sheet with opening 422, the second sidewall 42 has a soldering portion 424, and a recess 423 is set on the second sidewall 42 so as to lock the block portion 101. The elastic sheet 45 and the soldering sheet 43 extend from the rear end of the main portion 40, the said soldering sheet 43 has a soldering portion 431, a via hole 451 is defined on the elastic sheet 45 and cooperates with the projection on the backwall 14, the soldering sheet 43 receives in the recess 141, the recess 141 forms a flat portion 1410 on the base 13 to provide a space for containing the soldering paste.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

While preferred embodiment in accordance with the present invention have been shown and described, equivalent modifications and changes known to persons skilled in the art according to the spirit of the present invention are considered within the scope of the present invention as defined in the appended claims.

What is claimed is:

1. An electrical card connector comprising an insulative housing and a plurality of contacts, the insulative housing has a base, a retention rib, and two sidewalls extended from the two sides, a plurality of pinholes are defined on the insulative housing receiving corresponding contacts, wherein at least one of the contacts has a supporting patch extended from the side, the supporting patch is molded with the retention rib.

2. The electrical card connector as recited in claim 1, wherein the end of the supporting patch protrudes from the end of the contact.

3. The electrical card connector as recited in claim 1, wherein a plurality of openings are defined on the metal cover, a plurality of protruding portions on the insulative housing cooperating with the openings.

4. The electrical card connector as recited in claim 3, wherein the supporting portions are defined on the sidewalls of the insulative housing.

5. The electrical card connector as recited in claim 1, wherein a backwall extended upwardly from the rear end of the base.

6. The electrical card connector as recited in claim 1, wherein a positioning portion is defined on front-end of the sidewall, and on the front-end of the other sidewall, a soldering portion is defined thereon.

7. The electrical card connector as recited in claim 1, wherein the electrical card connector further includes an ejector.

8. The electrical card connector as recited in claim 7, wherein ejector includes a lock sheet.

9. An electrical connector comprising:
an insulative housing defining a longitudinal direction and transverse direction perpendicular to said longitudinal direction; and
a plurality of contacts each extending along the longitudinal direction while being integrated together via an insulative bar extending in said transverse direction; wherein
said housing further defines an insulative retention rib for mounting to a printed circuit board, and one of said contacts unitarily forms a support patch embedded within said retention rib for reinforcement of said retention rib.

10. The electrical connector as claimed in claim 9, wherein said retention rib is located on an outermost transverse side of the housing, and said one of the contacts is an outermost transverse one of all said contacts.

11. The electrical connector as claimed in claim 9, wherein said retention rib extends along the longitudinal direction.

12. The electrical connector as claimed in claim 9, wherein said insulative bar and said insulative retention rib are combined with the contacts with one step insert molding.

13. A method of making an reinforced electrical connector, comprising steps of:
providing a plurality of contacts in a juxtaposed manner, each extending along a longitudinal direction; and
forming an insulative housing enclosing said contacts via an insert molding process with an insulative bar unifying said contacts along a transverse direction perpendicular to said longitudinal direction; wherein at least one of said contacts provides an additional support patch enclosed, via said insert molding process, in a retention rib, which extends in a cantilevered manner from one end of said bar for mounting to a printed circuit board.

14. The method of claim 13, wherein said retention rib is located on an outermost transverse side of the housing and extending along said longitudinal direction.
